(19) United States
(12) Patent Application Publication
(10) Pub. No.: US 2025/0282180 A1
(43) Pub. Date: Sep. 11, 2025

(54) HEAVY DUTY TIRE

(71) Applicant: Sumitomo Rubber Industries, Ltd., Kobe-shi (JP)

(72) Inventors: Masayuki YOSHINO, Kobe-shi (JP); Keishi YAMAMOTO, Kobe-shi (JP)

(73) Assignee: Sumitomo Rubber Industries, Ltd., Kobe-shi (JP)

(21) Appl. No.: 19/070,573

(22) Filed: Mar. 5, 2025

(30) Foreign Application Priority Data
Mar. 6, 2024 (JP) 2024-033667

(51) Int. Cl. B60C 9/18; B60C 15/06; B60C 19/00

(52) U.S. Cl. CPC B60C 9/18; B60C 19/00; B60C 2015/0614; B60C 2200/06

(57) ABSTRACT

A heavy duty tire includes a tread, sidewalls, beads, a carcass, a belt, chafers, and a tag holder including an RFID tag. In the tire, the carcass includes a carcass ply including carcass cords, and the carcass cords are formed from an organic fiber. The carcass ply includes a ply body extending between the beads and turned-up portions each connected to the ply body and turned up around the bead. In a standard ground-contact state, an end of the turned-up portion is axially inward of an axially outer end of a rim, and the RFID tag is axially outward of the axially outer end of the rim and is radially outward of a radially outer end of the rim. In the tire, an angle formed between a length direction of the RFID tag and the carcass cord is not less than 80 degrees and not greater than 90 degrees.

### CROSS-REFERENCE TO RELATED APPLICATION

The present application claims priority to Japanese Application No. JP 2024-033667, filed on Mar. 6, 2024, the entire contents of which are incorporated herein by reference.

### FIELD

The present disclosure relates to a heavy duty tire.

### BACKGROUND ART

In order to manage data regarding manufacturing management, customer information, running history, etc., of tires, tires on which radio frequency identification (RFID) tags that perform reading and writing via radio waves are mounted, have been considered. Various studies have been conducted for a technology to mount an RFID tag to a tire (for example, Japanese Laid-Open Patent Publication No. 2021-046057).

Japanese Laid-Open Patent Publication No. 2021-046057 proposes a technology to mount an RFID tag to a heavy duty tire used for a truck or a bus.

Meanwhile, steel cords are generally adopted as tire cords, such as carcass cords, in heavy duty tires used for trucks and buses.

In the case where an RFID tag is mounted to a tire in which steel cords are adopted as carcass cords, the steel cords may become a barrier to radio waves, so that reading of data from the RFID tag could be easily impeded.

One or more embodiments may provide a heavy duty tire having good performance in reading data from an RFID tag and good durability.

In the present disclosure, good durability of the tire means that the tire has a long runnable distance and the RFID tag is less likely to be damaged.

### SUMMARY

A heavy duty tire according to one aspect of the present disclosure includes:
a tread;
a pair of sidewalls each connected to an end of the tread and located radially inward of the tread;
a pair of beads each located radially inward of the sidewall;
a carcass located inward of the tread and the pair of sidewalls and extending on and between one bead and the other bead;
a belt stacked on the carcass on a radially inner side of the tread;
a pair of chafers each located radially inward of the sidewall and configured to come into contact with a rim; and
a tag member including an RFID tag, wherein
the bead includes a core and an apex located radially outward of the core,
the carcass includes a carcass ply including a plurality of carcass cords aligned with each other,
the carcass cords are formed from an organic fiber,
the carcass ply includes a ply body extending between the pair of beads and a pair of turned-up portions each connected to the ply body and turned up around the bead,
the rim is a standardized rim,
a state where the tire is fitted on the rim and an internal pressure of the tire is adjusted to a standardized internal pressure is a standardized state,
a state where a load that is 50% of the standardized load is applied to the tire in the standardized state and the tire is brought into contact with a flat surface is a standard ground-contact state,
in the standard ground-contact state, an end of the turned-up portion is located inward of an axially outer end of the rim in an axial direction,
in the standard ground-contact state, the RFID tag is located outward of the axially outer end of the rim in the axial direction and is located outward of a radially outer end of the rim in a radial direction, and
an angle formed between a length direction of the RFID tag and the carcass cord is not less than 80 degrees and not greater than 90 degrees.

According to the present disclosure, it is possible to provide a heavy duty tire having good performance in reading data from an RFID tag and good durability.

### BRIEF DESCRIPTION OF THE DRAWINGS

FIG. 1 is a cross-sectional view showing a part of a heavy duty tire according to one embodiment of the present disclosure;

FIG. 2 is a cross-sectional view showing a part of the heavy duty tire in FIG. 1;

FIG. 3 is a plan view of a tag member;

FIG. 4 is a cross-sectional view taken along a line IV-IV in FIG. 3;

FIG. 5 is a cross-sectional view showing a part of the heavy duty tire in a ground-contact state;

FIG. 6 illustrates an angle formed between the length direction of an RFID tag and a carcass cord; and

FIG. 7 is a cross-sectional view showing a part of a heavy duty tire according to another embodiment of the present disclosure.

### DETAILED DESCRIPTION

The tire of the present disclosure may be fitted on a rim. The interior of the tire may be filled with air to adjust the internal pressure of the tire. The tire fitted on the rim is also referred to as tire-rim assembly. The tire-rim assembly may include the rim and the tire fitted on the rim.

In the present disclosure, a state where a tire is fitted on a standardized rim, the internal pressure of the tire is adjusted to a standardized internal pressure, and no load is applied to the tire may be referred to as standardized state.

In the present disclosure, unless otherwise specified, the dimensions and angles of each component of the tire are measured in the standardized state.

The dimensions and angles of each component in a meridian cross-section of the tire, which cannot be measured in a state where the tire is fitted on the standardized rim, are measured in a cut plane of the tire obtained by cutting the tire along a plane including a rotation axis. In this measurement, the tire may be set such that the distance between right and left beads is equal to the distance between the beads in the tire that is fitted on the standardized rim. The configuration of the tire that cannot be confirmed in a state where the tire is fitted on the standardized rim may be confirmed in the above-described cut plane.

The standardized rim means a rim specified in a standard on which the tire is based. The “standard rim” in the JATMA standard, the “Design Rim” in the TRA standard, and the “Measuring Rim” in the ETRTO standard are standardized rims.

The standardized internal pressure means an internal pressure specified in the standard on which the tire is based. The “highest air pressure” in the JATMA standard, the “maximum value” recited in the “TIRE LOAD LIMITS AT VARIOUS COLD INFLATION PRESSURES” in the TRA standard, and the “INFLATION PRESSURE” in the ETRTO standard are standardized internal pressures.

A standardized load means a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard are standardized loads.

In the present disclosure, a crosslinked rubber may be a molded product obtained by pressurizing and heating a rubber composition. The crosslinked rubber may be a crosslinked product of the rubber composition. The rubber composition may be a material obtained by mixing a base rubber and chemicals in a kneading machine such as a Banbury mixer. The base rubber of the rubber composition may not be crosslinked. The base rubber of the crosslinked rubber may be crosslinked. The crosslinked rubber may also be referred to as vulcanized rubber, and the rubber composition may also be referred to as unvulcanized rubber.

Examples of the base rubber may include natural rubber (NR), butadiene rubber (BR), styrene-butadiene rubber (SBR), isoprene rubber (IR), ethylene-propylene rubber (EPDM), chloroprene rubber (CR), acrylonitrile-butadiene rubber (NBR), and isobutylene-isoprene-rubber (IIR). Examples of the chemicals may include reinforcing agents such as carbon black and silica, plasticizers such as aromatic oil, fillers such as zinc oxide, lubricants such as stearic acid, antioxidants, processing aids, sulfur, and vulcanization accelerators. Selection of a base rubber and chemicals, the amounts of the selected chemicals, etc., may be determined as appropriate according to the specifications of components, such as a tread and a sidewall, for which the rubber composition is used.

In the present disclosure, a tire may include a tread portion, a pair of bead portions, and a pair of sidewall portions as portions thereof. The tread portion may be a portion of the tire that comes into contact with a road surface. Each bead portion may be a portion of the tire that is fitted to a rim. Each sidewall portion may be a portion of the tire that extends between the tread portion and the bead portion.

In the present disclosure, a complex elastic modulus of a component formed from a crosslinked rubber, of the components included in the tire, may be measured according to the standards of JIS K6394. The measurement conditions are as follows.
Initial strain=10%
Dynamic strain=±1%
Frequency=10 Hz
Mode=stretch mode
Temperature=70° C.

In this measurement, a test piece (a length of 40 mm× a width of 4 mm× a thickness of 1 mm) is sampled from the tire. The length direction of the test piece is caused to coincide with the circumferential direction of the tire. When a test piece cannot be sampled from the tire, a test piece is sampled from a sheet-shaped crosslinked rubber (hereinafter, also referred to as rubber sheet) obtained by pressurizing and heating a rubber composition, which is used for forming the component to be measured, at a temperature of 170° C. for 12 minutes.

In the present disclosure, the complex elastic modulus is represented as a complex elastic modulus at 70° C.

[Findings on which Present Disclosure is Based]

In the case where an RFID tag is mounted to a heavy duty tire, the RFID tag may be generally embedded in a bead portion.

Heavy duty tires used for trucks and buses may be all-steel tires in which steel cords are used as a reinforcing material for both a carcass and a belt due to the conditions of use. The amount of steel (metal) in an all-steel tire may be large, so that the exchange of radio waves by an RFID tag mounted on the all-steel tire could be impeded by the metal and the all-steel tire could have poor reading performance.

In the case where a heavy duty tire on which an RFID tag is mounted on a vehicle, depending on the mounting position of the RFID tag on the tire, the exchange of radio waves could be impeded by a metal rim such as an aluminum wheel, and as a result, the reading operation could become difficult.

Regarding addressing these issues, for the latter, it is possible to consider mounting the RFID tag at a position away from the metal wheel, which can address the issue.

Meanwhile, for the former, it is possible to consider replacing cords made of steel (hereinafter referred to as steel cords) with cords made of an organic fiber (hereinafter referred to as organic fiber cords). In the case where organic fiber cords are used as carcass cords instead of steel cords, the strain in the vicinity of an end of each turned-up portion of a carcass could become larger, thereby reducing the durability of a heavy duty tire.

Therefore, the present inventors have examined ensuring good reading performance of an RFID tag without impairing the durability of a heavy duty tire.

As a result, the present inventors have found that it is possible to ensure good reading performance of an RFID tag without impairing the durability of a heavy duty tire, by mounting a tag holder or tag member including the RFID tag to the tire at a predetermined position in a predetermined orientation, adopting organic fiber cords as carcass cords, and providing a carcass such that an end of a turned-up portion of a carcass ply is at a predetermined position, and thus have completed the disclosure described below.

### DETAILS OF EMBODIMENTS OF PRESENT DISCLOSURE

Hereinafter, the present disclosure will be described in detail based on embodiments with appropriate reference to the drawings.

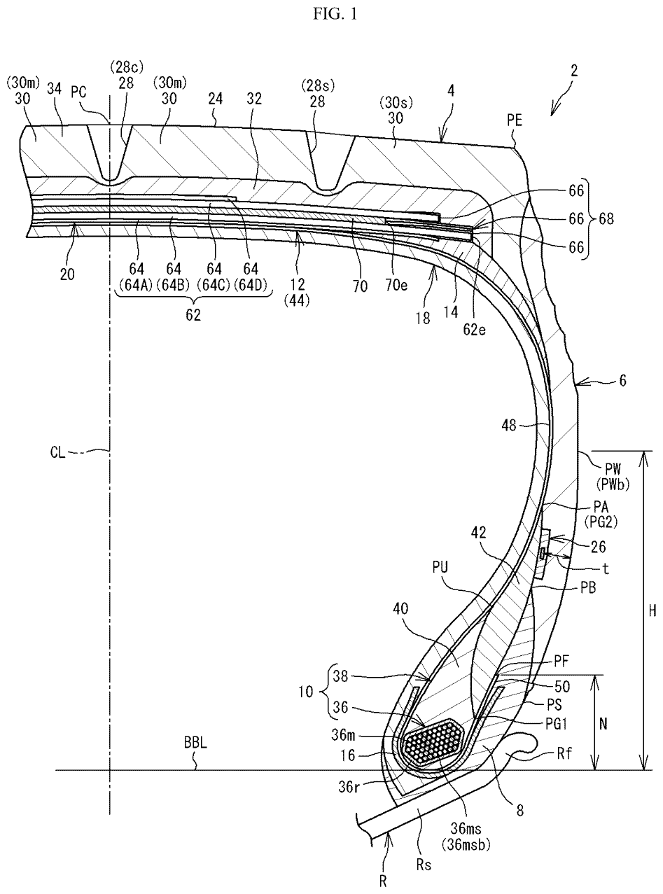

FIG. 1 shows a part of a heavy duty tire 2 (hereinafter also referred to simply as “tire 2”), according to one embodiment of the present disclosure. The tire 2 may be mounted to a vehicle such as a truck or a bus.

In FIG. 1, the tire 2 may be fitted on a rim R (standardized rim).

FIG. 1 shows a part of a cross-section (hereinafter referred to as meridian cross-section) of the tire 2 along a plane including the rotation axis of the tire 2. In FIG. 1, the right-left direction is the axial direction of the tire 2, and the up-down direction is the radial direction of the tire 2. The direction perpendicular to the surface of the drawing sheet of FIG. 1 is or includes the circumferential direction of the tire 2.

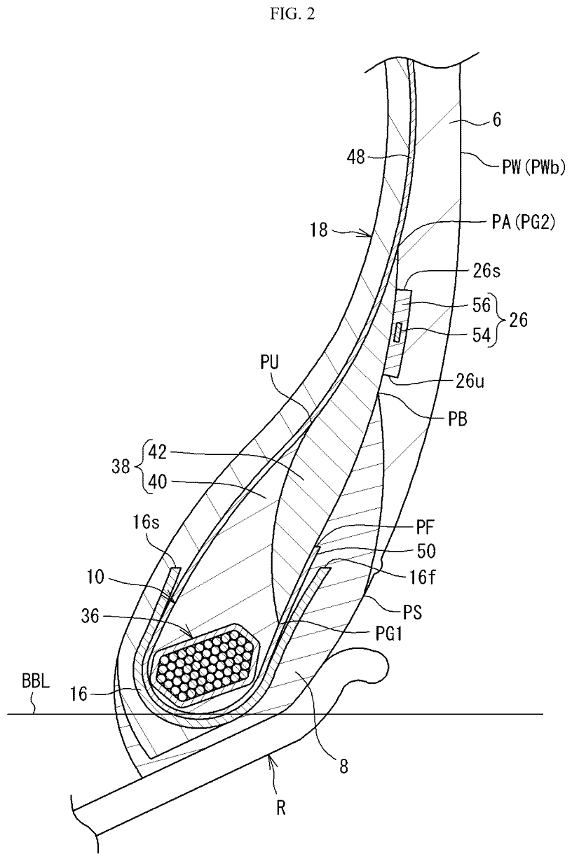

FIG. 2 shows a part of the cross-section shown in FIG. 1.

In FIG. 1, an alternate long and short dash line CL extending in the radial direction represents the equator plane of the tire 2. In FIG. 1 and FIG. 2, a solid line BBL extending in the axial direction is a bead base line. The bead base line BBL is a line that defines the rim diameter (see JATMA or the like) of the rim R.

The tire 2 may include a tread 4, a pair of sidewalls 6, a pair of chafers 8, a pair of beads 10, a carcass 12, a pair of cushion layers 14, a pair of steel fillers 16, an inner liner 18, a reinforcing layer 20, and a tag holder or tag member 26.

The tread 4 may be located radially outward of the carcass 12. The tread 4 may come into contact with a road surface at a tread surface 24 thereof. At least three circumferential grooves 28 may be formed on the tread 4. Accordingly, at least four land portions 30 may be formed in the tread 4.

On the tread 4 of the tire 2 shown in FIG. 1, three circumferential grooves 28 may be formed, whereby four land portions 30 may be formed therein. These land portions 30 may be aligned in the axial direction and extend continuously in the circumferential direction.

Among the three circumferential grooves 28 formed on the tread 4, the circumferential groove 28 located on each outer side in the axial direction may be a shoulder circumferential groove 28s. The circumferential groove 28 sandwiched between two shoulder circumferential grooves 28s in the axial direction and located on the equator plane CL may be a center circumferential groove 28c. In the tire 2, the three circumferential grooves 28 may be composed of such a center circumferential groove 28c and a pair of such shoulder circumferential grooves 28s.

Among the four land portions 30 formed in the tread 4, the land portion 30 located on each outer side in the axial direction may be a shoulder land portion 30s. The shoulder land portion 30s may be located outward of the shoulder circumferential groove 28s in the axial direction and may include an end PE of the tread surface 24. The land portion 30 located inward of the shoulder land portion 30s in the axial direction may be a middle land portion 30m. The middle land portion 30m may be located between the center circumferential groove 28c and the shoulder circumferential groove 28s in the axial direction. In the tire 2, the four land portions 30 may be composed of a pair of such middle land portions 30m and a pair of such shoulder land portions 30s.

The tread 4 may include a base portion 32 and a cap portion 34 located radially outward of the base portion 32. The base portion 32 may be formed from a crosslinked rubber that has low heat generation properties. The cap portion 34 may be formed from a crosslinked rubber for which wear resistance and grip performance are taken into consideration. As shown in FIG. 1, the base portion 32 may cover the entire reinforcing layer 20. The cap portion 34 may cover the entire base portion 32. The cap portion 34 may include the tread surface 24.

In FIG. 1, a position indicated by reference character PC corresponds to an equator. The equator PC is the point of intersection of the tread surface 24 and the equator plane CL. In the case where the groove 28 is located on the equator plane CL as in the tire 2, the equator PC is specified on the basis of a virtual tread surface obtained on the assumption that the groove 28 is not present thereon.

The distance in the radial direction, from the bead base line BBL to the equator PC, obtained in the tire 2 in the standardized state is the cross-sectional height (see JATMA or the like) of the tire 2.

Each sidewall 6 may be connected to an end of the tread 4. The sidewall 6 may be located radially inward of the tread 4. The sidewall 6 may be located axially outward of the carcass 12. A position indicated by reference character PS is an inner end of the sidewall 6.

The sidewall 6 may be formed from a crosslinked rubber for which cut resistance is taken into consideration. The complex elastic modulus of the sidewall 6 may be not less than 2.0 MPa and not greater than 6.0 MPa.

A position indicated by reference character PW is an axially outer end of the tire 2 (hereinafter referred to as outer end PW). In the case where decorations such as patterns and letters are present on the outer surface of the tire 2, the outer end PW may be specified on the basis of a virtual outer surface obtained on the assumption that the decorations are not present thereon. The tire 2 may have a maximum width at the outer end PW. The outer end PW may also be referred to as maximum width position.

In the present disclosure, the maximum width position PW in the tire 2 in the standardized state is a reference maximum width position PWb. The distance in the axial direction from one reference maximum width position PWb to another reference maximum width position PWb is the cross-sectional width (see JATMA or the like) of the tire 2.

In FIG. 1, a length indicated by reference character H is the distance in the radial direction from the bead base line BBL to the reference maximum width position PWb. The distance H in the radial direction is also referred to as radial height of the reference maximum width position PWb.

In the tire 2 in the standardized state, the ratio of the radial height H of the reference maximum width position PWb to the cross-sectional height may be not less than 0.40 and not greater than 0.60.

Each chafer 8 may be located radially inward of the sidewall 6. The chafer 8 may come into contact with the rim R. A position indicated by reference character PB is an outer end of the chafer 8.

The chafer 8 may be formed from a crosslinked rubber for which wear resistance is taken into consideration. The complex elastic modulus of the chafer 8 may be not less than 10 MPa and not greater than 15 MPa. The chafer 8 may be harder than the sidewall 6.

Each bead 10 may be located axially inward of the chafer 8. The bead 10 may be located radially inward of the sidewall 6. The bead 10 may include a core 36 and an apex 38.

The core 36 may extend in the circumferential direction. The core 36 may include a core body 36m and a wrapping layer 36r.

The core body 36m may be a ring extending in the circumferential direction. The core body 36m may include a wire made of steel and wound in the circumferential direction. A cross-sectional shape of the core body 36m may be shaped by winding the wire in a regular manner. Accordingly, in a cross-section of the core body 36m, cross-sectional units each including a plurality of wire cross-sections aligned substantially in the axial direction are stacked in a plurality of stages substantially in the radial direction. The cross-sectional shape of the core body 36m may be represented by a line that circumscribes the core body 36m. In an implementation, as shown in FIG. 1, the core body 36m may have a hexagonal cross-sectional shape. In an implementation, the core body 36m may have a quadrangular cross-sectional shape.

The core body 36m may generally have six side surfaces 36ms. As shown in FIG. 1, one side surface 36msb out of the six side surfaces 36ms may be located so as to face a seat Rs of the rim R. In the present embodiment, the side surface 36msb which is located so as to face the seat Rs of the rim R may be a bottom surface of the core body 36m. The core body 36m may have the bottom surface 36msb which is located so as to face the seat Rs of the rim R. In the meridian cross-section of the tire 2, the contour of the bottom surface 36msb may be represented by a straight line.

The wrapping layer 36r may surround the core body 36m. The wrapping layer 36r may cover the core body 36m. The wrapping layer 36r may help prevent the core body 36m from falling apart.

The configuration of the wrapping layer 36r may be a suitable configuration in which the wrapping layer 36r may help prevent the core body 36m from falling apart. The wrapping layer 36r may be composed of a cord helically wound around the core body 36m, a rubberized fabric wrapped around the core body 36m, or the like.

The apex 38 may be located radially outward of the core 36. The apex 38 may extend radially outward from the core 36. The apex 38 may be tapered outward. An outer end PA of the apex 38 may be located radially outward of the outer end PB of the chafer 8.

The apex 38 may include an inner apex 40 and an outer apex 42. The inner apex 40 may be located radially outward of the core 36. The outer apex 42 may be located radially outward of the inner apex 40.

The inner apex 40 may be tapered outward. The inner apex 40 may be formed from a hard crosslinked rubber. The complex elastic modulus of the inner apex 40 may be not less than 60 MPa and not greater than 90 MPa.

The outer apex 42 may be thick around an outer end PU of the inner apex 40. The outer apex 42 may be tapered inward and tapered outward from the thick portion thereof.

An inner end PG1 of the outer apex 42 may be located near the core 36. An outer end PG2 of the outer apex 42 may also be the outer end PA of the apex 38.

The outer apex 42 may be formed from a crosslinked rubber. The outer apex 42 may be softer than the inner apex 40. The complex elastic modulus of the outer apex 42 may be not less than 3.0 MPa and not greater than 6.0 MPa.

The carcass 12 may be located inward of the tread 4, the pair of sidewalls 6, and the pair of chafers 8. The carcass 12 may extend on and between the pair of beads 10. The carcass 12 of the tire 2 may have a radial structure.

The carcass 12 may include at least one carcass ply 44. The carcass 12 of the tire 2 may be composed of one carcass ply 44. The carcass ply 44 may be turned up around each bead 10.

The carcass ply 44 may include a ply body 48 and a pair of turned-up portions 50. The ply body 48 may extend between the pair of beads 10, e.g., between one bead 10 and the other bead 10. Each turned-up portion 50 may be connected to the ply body 48 and turned up around the bead 10. The turned-up portion 50 of the tire 2 may be turned up around the bead 10 from the inner side toward the outer side in the axial direction. The turned-up portion 50 may be turned up such that an end PF of the turned-up portion 50 is located axially outward of the apex 38.

In the tire 2 according to the present embodiment, the end PF of the turned-up portion 50 may be at a predetermined position. The specific position will be described below.

In the tire 2, each bead 10 may be between the ply body 48 and the turned-up portion 50.

The carcass ply 44 may include a large number of carcass cords aligned with each other, which are not shown in FIGS. 1 and 2. These carcass cords may be covered with a topping rubber. Each carcass cord may intersect the equator plane CL. The material of the carcass cord may be an organic fiber. The carcass cord may be an organic fiber cord. Examples of the organic fiber may include nylon fibers, polyester fibers, rayon fibers, and aramid fibers.

In the tire 2, the carcass cords may be organic fiber cords, and blocking of radio waves, exchanged by an RFID tag 54, by the carcass cords may be suppressed.

In an implementation, as the organic fiber cords, cords made of an aramid fiber (hereinafter referred to as “aramid cords”) may be used, with a view toward having durability and heat resistance similar to steel cords.

In an implementation, the aramid fiber that is the material of the aramid cords may be a para-aramid fiber. In an implementation, as the carcass cords adopted in the tire 2, cords made of a para-aramid fiber (hereinafter referred to as “para-aramid cords”) may be used.

In FIG. 1, a length indicated by reference character N is the distance in the radial direction from the bead base line BBL to the end PF of the turned-up portion 50. The distance N in the radial direction is also referred to as radial height of the end PF of the turned-up portion 50.

In the tire 2, the ratio (N/H) of the radial height N of the end PF of the turned-up portion 50 to the radial height H of the reference maximum width position PWb may be not less than 0.20 and not greater than 0.40.

Each cushion layer 14 may be located between the reinforcing layer 20 and the carcass 12 at an end of the reinforcing layer 20. The cushion layer 14 may be formed from a soft crosslinked rubber.

Each steel filler 16 may be located at a bead portion. The steel filler 16 may be turned up from the inner side toward the outer side in the axial direction around each core 36 along the carcass ply 44. The steel filler 16 may be placed so as to wrap a radially inner portion of the bead 10 from the radially inner side of the turned-up portion 50.

The steel filler 16 may include a large number of filler cords aligned with each other. The material of the filler cords may be steel. The steel filler 16 may include steel cords. In the steel filler 16, the steel cords may be covered with a topping rubber.

An outer end 16f of the steel filler 16 may be located axially outward of the turned-up portion 50. The outer end 16f may be located radially inward of the end PF of the turned-up portion 50. An inner end 16s of the steel filler 16 may be located axially inward of the ply body 48. The position in the radial direction of the inner end 16s only needs to substantially coincide with that of the outer end 16f, and the inner end 16s may be located radially outward of the outer end 16f or may be located radially inward of the outer end 16f.

The inner liner 18 may be located inward of the carcass 12. The inner liner 18 may be joined to the inner surface of the carcass 12 via an insulation formed from a crosslinked rubber. The inner liner 18 may form an inner surface of the tire 2. The inner liner 18 may be formed from a crosslinked rubber that has an excellent air blocking property.

The reinforcing layer 20 may be located inward of the tread 4 in the radial direction. The reinforcing layer 20 may be located between the carcass 12 and the tread 4. The reinforcing layer 20 may include a belt 62 and a band 70. The stiffness of a tread portion may be increased by the reinforcing layer 20.

The belt 62 may include a plurality of belt plies 64 aligned in the radial direction. Each belt ply 64 may be placed such that both ends thereof are opposed to each other across the equator plane CL. In an implementation, the belt 62 of the tire 2 may include four belt plies 64. The four belt plies 64 may include a first belt ply 64A located on the inner side in the radial direction, a second belt ply 64B located outward of the first belt ply 64A, a third belt ply 64C located outward of the second belt ply 64B, and a fourth belt ply 64D located outward of the third belt ply 64C.

In the tire 2, the second belt ply 64B may have a widest width in the axial direction, and the fourth belt ply 64D may have a narrowest width in the axial direction. The first belt ply 64A and the third belt ply 64C may have the same width in the axial direction, or the width in the axial direction of the first belt ply 64A may be wider than the width in the axial direction of the third belt ply 64C.

An end 62e of the belt 62 of the tire 2 may be represented as an end of the belt ply 64 having a widest width in the axial direction among the plurality of belt plies 64 included in the belt 62. In the tire 2, as described above, among the four belt plies 64 included in the belt 62, the second belt ply 64B may have a widest width in the axial direction. The end 62e of the belt 62 of the tire 2 may be represented as an end of the second belt ply 64B having a widest width in the axial direction.

As shown in FIG. 1, an end of the first belt ply 64A, the end of the second belt ply 64B, and an end of the third belt ply 64C may be located outward of the shoulder circumferential groove 28s in the axial direction. An end of the fourth belt ply 64D may be located inward of the shoulder circumferential groove 28s in the axial direction.

In the tire 2, each belt ply 64 included in the belt 62 may include a large number of belt cords aligned with each other. The belt cords may be covered with a topping rubber. The belt cords of the tire 2 may be steel cords.

In the tire 2, the density of the belt cords in each belt ply 64 may be not less than 15 ends/5 cm and not greater than 30 ends/5 cm. The density of the belt cords may be represented as the number of cross-sections of the belt cords included per 5 cm width of the belt ply 64 in a cross-section of the belt ply 64 along a plane perpendicular to the direction in which the belt cords extend.

In each belt ply 64, the belt cords may be inclined with respect to the circumferential direction. In the tire 2, as the direction of inclination of the belt cords included in each belt ply 64 with respect to the circumferential direction (hereinafter referred to as inclination direction of the belt cords), any direction can be selected independently for each belt ply 64. In the tire 2, from the viewpoint of ensuring a stable ground-contact shape, the inclination direction of the belt cords of the second belt ply 64B may be opposite to the inclination direction of the belt cords of the third belt ply 64C.

The inclination angle of the belt cords included in each belt ply 64 with respect to the circumferential direction may be appropriately selected within a range of, e.g., not less than 10 degrees and not greater than 60 degrees.

The band 70 may have two ends 70e opposed to each other across the equator plane CL. The band 70 may include a helically wound band cord. The band cord may be covered with a topping rubber.

In the tire 2, the band cord may be a steel cord or an organic fiber cord. Examples of the material of the organic fiber cord may include nylon fibers, polyester fibers, rayon fibers, and aramid fibers.

In an implementation, the band cord may be a steel cord.

As described above, the band 70 may include the helically wound band cord. The band 70 may have a jointless structure. In the band 70, an angle of the band cord with respect to the circumferential direction of the tire 2 may be, e.g., not greater than 5 degrees or not greater than 2 degrees. The band cord of the band 70 may extend substantially in the circumferential direction.

The density of the band cord in the band 70 may be not less than 20 ends/5 cm and not greater than 35 ends/5 cm. The density of the band cord may be represented as the number of cross-sections of the band cord included per 5 cm width of the band 70 in a cross-section of the band 70 along a plane perpendicular to the direction in which the band cord extends.

In the tire 2, each of the end of the second belt ply 64B and the end of the third belt ply 64C may be covered with a rubber layer 66. Between the end of the second belt ply 64B and the end of the third belt ply 64C each covered with the rubber layer 66, two rubber layers 66 may be further placed. In the tire 2, an edge member 68 composed of a total of four rubber layers 66 may be formed between the end of the second belt ply 64B and the end of the third belt ply 64C. The edge member 68 may be formed from a crosslinked rubber. The edge member 68 may contribute to maintaining the interval between the end of the second belt ply 64B and the end of the third belt ply 64C. In the tire 2, a change in the positional relationship between the end of the second belt ply 64B and the end of the third belt ply 64C due to running may be suppressed. The edge member 68 may be a part of the reinforcing layer 20. The reinforcing layer 20 of the tire 2 may include a pair of such edge members 68 in addition to the belt 62 and the band 70.

As described above, the band 70 may have the two ends 70e opposed to each other across the equator plane CL. The band 70 may extend in the axial direction from the equator plane CL toward each end 70e. Each end 70e of the band 70 may be located outward of the shoulder circumferential groove 28s in the axial direction. In the radial direction, the band 70 may be located inward of each shoulder circumferential groove 28s.

In the tire 2, the band 70 may help suppress growth of the carcass 12 due to running and may help suppresses a shape change of the tire 2. Therefore, an increase in strain in the vicinity of the end PF of each turned-up portion 50 of the carcass 12 during running may be suppressed. Therefore, the durability of the tire 2 may be better than that of a tire in which no band 70 is provided.

In the tire 2, each end 70e of the band 70 may be located inward of the end 62e of the belt 62 in the axial direction. The belt 62 may be wider than the band 70. The belt 62 may constrain each end 70e of the band 70. The belt 62 may help suppress fluctuation of the tension of the band cord included in the band 70. Occurrence of a break of the band cord due to tension fluctuation may be suppressed, so that the band 70 may stably exhibit the function of suppressing a shape change. In an implementation, each end 70e of the band 70 may be located inward of the end 62e of the belt 62 in the axial direction.

A force may act on the band 70 of the tire 2 so as to spread from the inner side toward the outer side in the radial direction. This force may cause tension in the band cord of the band 70.

In the tire 2, in the radial direction, the second belt ply 64B may be located inward of the band 70, and the third belt ply 64C may be located outward of the band 70. In the tire 2, the band 70 may be interposed between the second belt ply 64B and the third belt ply 64C. The second belt ply 64B may be wider than the band 70. The third belt ply 64C may also be wider than the band 70. The plurality of belt plies 64 included in the belt 62 of the tire 2 may include two belt plies 64 having a width wider than the width of the band 70, and the band 70 may be interposed between these belt plies 64 having a wide width. In the tire 2, fluctuation of the tension of the band cord included in the band 70 may be more effectively suppressed, so that a break may be less likely to occur in the band cord of the band 70. The band 70 of the tire 2 can stably exhibit the function of suppressing a shape change. In an implementation, in the tire 2, the plurality of belt plies 64 included in the belt 62 may include two belt plies 64 having a width wider than the width of the band 70, and the band 70 may be interposed between these belt plies 64 having a wide width.

In the tire 2, the first belt ply 64A, the second belt ply 64B, and the third belt ply 64C may have a width wider than the width of the band 70. In the radial direction, the first belt ply 64A and the second belt ply 64B may be located inward of the band 70, and the third belt ply 64C and the fourth belt ply 64D may be located outward of the band 70.

The tag member 26 may be located axially outward of the bead 10. In the tire 2, the tag member 26 may be provided only on the side of one sidewall 6. In an implementation, the tag member 26 may be provided on each of the side of one sidewall 6 and the side of the other sidewall 6. In an implementation, from the viewpoint of reducing the risk of damage, the tag member 26 may be provided only on the side of one sidewall 6 out of the pair of sidewalls 6.

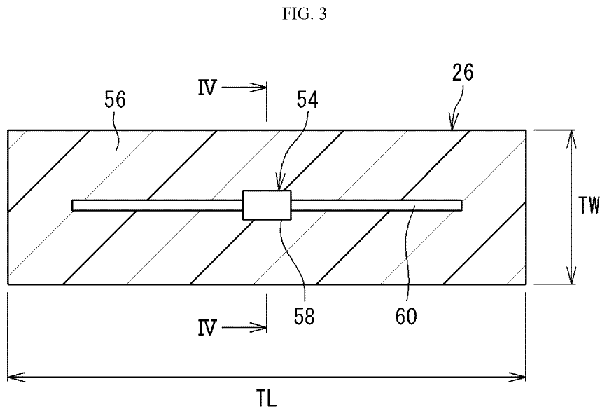

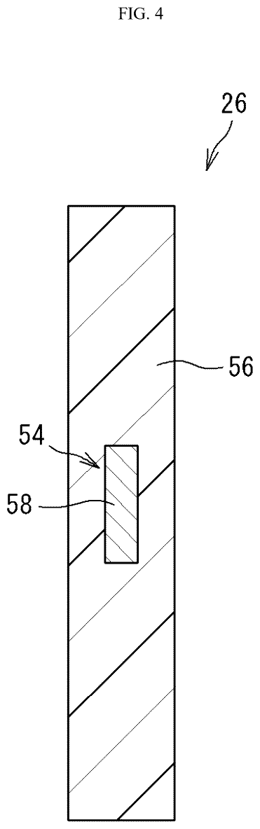

FIG. 3 is a plan view of the tag member 26. FIG. 4 is a cross-sectional view taken along a line IV-IV in FIG. 3.

The tag member 26 may have a plate shape. The tag member 26 may be long in a length direction thereof and short in a width direction thereof. As shown in FIG. 1, in the tire 2, the tag member 26 may be placed such that a first end 26s in the length direction thereof is located on or facing the radially outer side in the tire 2 and a second end 26u in the length direction thereof is located on or facing the radially inner side in the tire 2. In the tire 2, the first end 26s may also be referred to as outer end, and the second end 26u may also be referred to as inner end.

The tag member 26 may include the RFID tag 54. In FIG. 3, for convenience of description, the RFID tag 54 is shown by a solid line, and the entirety thereof may be covered with a protector 56. The tag member 26 may include the RFID tag 54 and the protector 56. The RFID tag 54 may be located at the center of the tag member 26. The protector 56 may be formed from a crosslinked rubber. The protector 56 may have stiffness substantially equal to the stiffness of the outer apex 42. In the tire 2, formation of a good communication environment may be considered, and a crosslinked rubber having high electrical resistance may be used for the protector 56. The protector 56 may be formed from a rubber that has high insulation properties.

In an implementation, the RFID tag 54 may be a small and lightweight electronic component that includes, e.g., a semiconductor chip 58 obtained by making a transmitter/receiver circuit, a control circuit, a memory, or the like, into a chip; and an antenna 60. Upon receiving interrogation radio waves, the RFID tag 54 may use the radio waves as electrical energy and transmits various data in the memory as response radio waves. The RFID tag 54 may be a type of passive radio frequency identification transponder.

In the RFID tag 54, the antenna 60 may extend in the length direction of the RFID tag 54 (the right-left direction in FIG. 3) from the semiconductor chip 58. As shown in FIG. 3, the RFID tag 54 may include a pair of such antennas 60 provided so as to extend in the length direction thereof, and the semiconductor chip 58 located between the pair of antennas 60. In the tag member 26, the RFID tag 54 may be placed such that the length direction of the RFID tag 54 coincides with the length direction of the tag member 26.

The shape of each antenna 60 shown in FIG. 3 is an example, and each antenna 60 included in the RFID tag 54 can take various shapes. The shape of each antenna 60 may be, e.g., a shape extending while bending, a helical shape, or the like.

In the embodiment of the present disclosure, the external dimensions (length, width, and thickness) of the RFID tag 54 are represented as the length, width, and thickness of the circumscribed rectangular parallelepiped of the RFID tag 54. The length of the RFID tag 54 may be equal to or larger than the width of the RFID tag 54. The width of the RFID tag 54 may be equal to or larger than the thickness of the RFID tag 54.

In addition, in the embodiment of the present disclosure, the length direction of the RFID tag 54 may also be the length direction of the antennas 60 included in the RFID tag 54. In an implementation, the length direction of the antennas 60 is the length direction of the RFID tag 54.

The tag member 26 may be a plate-shaped member in which the RFID tag 54 is covered with a crosslinked rubber (protector). In an implementation, from the viewpoint of reducing the risk of damage to the RFID tag 54 and forming a good communication environment, the thickness of the tag member 26 in the tire 2 may be not less than 1.0 mm and not greater than 2.5 mm. The thickness of the tag member 26 in the tire 2 may be represented as the maximum thickness of the tag member 26 at the semiconductor chip 58 of the RFID tag 54.

A length TL of the tag member 26 before embedding in the tire 2 may be not less than 60 mm and not greater than 80 mm, and a width TW thereof may be not less than 10 mm and not greater than 20 mm.

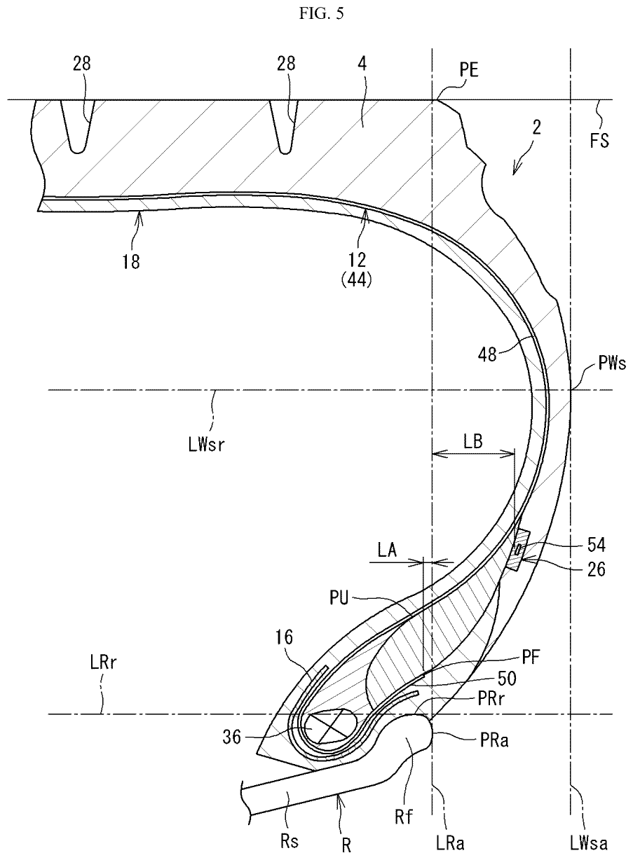

FIG. 5 shows a part of a meridian cross-section of the tire 2 in a ground-contact state. The cross-section in FIG. 5 is a trace of a cross-sectional image of the tire 2 taken, e.g., by a computer tomography method using X-rays (hereinafter referred to as X-ray CT method) in a state where a load that is 50% of the standardized load is applied to the tire 2 in the standardized state and the tire 2 is brought into contact with a flat surface FS.

In the present disclosure, the state where a load that is 50% of the standardized load is applied to the tire 2 in the standardized state and the tire 2 is brought into contact with the flat surface FS is also referred to as standard ground-contact state.

In the standard ground-contact state shown in FIG. 5, the camber angle of the tire 2 is set to 0 degrees.

In FIG. 5, a position indicated by reference character PRa is an axially outer end of a flange Rf of the rim R. An alternate long and short dash line indicated by reference character LRa is a straight line passing through the axially outer end PRa and extending in the radial direction.

A position indicated by reference character PRr is a radially outer end of the flange Rf. An alternate long and short dash line indicated by reference character LRr is a straight line passing through the radially outer end PRr and extending in the axial direction.

In FIG. 5, a position indicated by reference character PWs is the maximum width position of the tire 2 in the standard ground-contact state. An alternate long and short dash line indicated by reference character LWsa is a straight line passing through the maximum width position PWs and extending in the radial direction. An alternate long and short dash line indicated by reference character LWsr is a straight line passing through the maximum width position PWs and extending in the axial direction.

In FIG. 5, the tire 2 is shown in a simplified manner, and some of the components of the tire 2 shown in FIG. 1, such as the reinforcing layer 20, may be omitted.

As shown in FIG. 5, in the tire 2 in the standard ground-contact state, the RFID tag 54 may be located outward of the radially outer end PRr of the rim R in the radial direction. Therefore, radio waves may not be blocked by the rim R, and the performance in reading data from the RFID tag 54 may be good. In an implementation, in the standard ground-contact state, the RFID tag 54 may be located inward of the maximum width position PWs of the tire 2 in the radial direction. In this case, the RFID tag 54 may be placed at a position where bending is less likely to occur during running, so that the RFID tag 54 itself may be less likely to be damaged, and damage to the tire 2 starting from the location where the RFID tag 54 is placed may also be less likely to occur.

In the present disclosure, the fact that the RFID tag 54 is located outward of the radially outer end PRr of the rim R may mean that the entire semiconductor chip 58 of the RFID tag 54 is located outward of the radially outer end PRr of the rim R. In addition, the fact that the RFID tag 54 is located inward of the maximum width position PWs of the tire 2 may mean that the entire semiconductor chip 58 of the RFID tag 54 is located inward of the maximum width position PWs of the tire 2.

Moreover, in the tire 2 in the standard ground-contact state, in the axial direction, the RFID tag 54 may be located outward of the axially outer end PRa of the rim R, and the end PF of the turned-up portion 50 may be located inward of the axially outer end PRa of the rim R. In this case, the RFID tag 54 and the end PF of the turned-up portion 50 may be located away from each other in the axial direction. Therefore, an increase in strain in the vicinity of the end PF of the turned-up portion 50, which could otherwise occur due to the RFID tag 54, foreign matter for the tire, being close to the end PF, can be suppressed.

In the present disclosure, the fact that the RFID tag 54 is located outward of the axially outer end PRa of the rim R means that the entire semiconductor chip 58 of the RFID tag 54 may be located outward of the axially outer end PRa of the rim R.

In an implementation, from the above-described viewpoint, the mounting position of the tag member 26 mounted on the tire 2 may be a position at which the entire semiconductor chip 58 of the RFID tag 54 is included in a region surrounded by the alternate long and short dash lines LWsr and LWsa and the alternate long and short dash lines LRr and LRa in the standard ground-contact state.

Furthermore, in the tire 2, the RFID tag 54 may be placed away from the vicinity of the end of the flange Rf and the vicinity of the maximum width position PWs where large strain could occur if the RFID tag 54 were to be present therein. In the tire 2, promotion of an increase in strain by the presence of the RFID tag 54 may be suppressed.

In the tire 2, occurrence of damage due to the presence of the RFID tag 54 may be suppressed. Moreover, damage to the RFID tag 54 itself may also be suppressed.

In the tire 2, the RFID tag 54 may be incorporated therein, and good durability may be maintained.

In FIG. 5, a double-headed arrow LA indicates the distance in the axial direction between the end PF of the turned-up portion 50 and the axially outer end PRa of the rim R. A double-headed arrow LB indicates the distance in the axial direction between the RFID tag 54 and the axially outer end PRa of the rim R. Here, the distance LB in the axial direction between the RFID tag 54 and the axially outer end PRa of the rim R may be the shortest distance in the axial direction between the semiconductor chip 58 of the RFID tag 54 and the axially outer end PRa of the rim R.

In the tire 2, the distance LA in the axial direction and the distance LB in the axial direction may satisfy LA<LB. As already described, in order to ensure the reading performance of the RFID tag 54 while suppressing an increase in strain in the vicinity of the end PF of the turned-up portion 50, the distance in the axial direction between the end PF of the turned-up portion 50 and the RFID tag 54 may be large, but from the viewpoint of more easily ensuring the reading performance of the RFID tag 54, the RFID tag 54 may be far away from the rim R in the axial direction.

From the above-described viewpoint, the distance LB in the axial direction may be not less than 1.5 times and not greater than 8.0 times the distance LA in the axial direction.

The tire 2 may be a tire in which, in the standard ground-contact state shown in FIG. 5, the end PE of the tread surface 24 is located axially outward of the alternate long and short dash line indicated by reference character LRa.

The tire 2 may be a tire in which, in the standard ground-contact state shown in FIG. 5, the outer end PU of the inner apex 40 is located axially inward of the alternate long and short dash line indicated by reference character LRa.

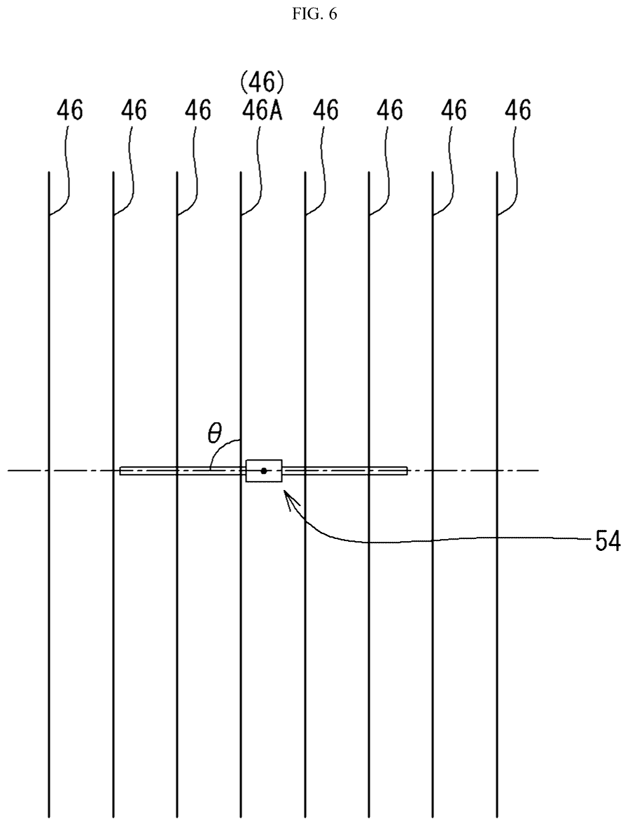

FIG. 6 illustrates an angle formed between the length direction of the RFID tag 54 and the carcass cord. FIG. 6 illustrates the positional relationship between the RFID tag 54 and the carcass cords when a part of the tire 2 is viewed in the axial direction. Therefore, in FIG. 6, the direction penetrating the drawing sheet thereof is the axial direction of the tire 2. As the angle formed between the length direction of the RFID tag 54 and the carcass cord, an angle on the acute side is adopted, except when this angle is 90 degrees.

In the tire 2, the RFID tag 54 may be mounted in a predetermined orientation. In an implementation, an angle θ formed between a carcass cord 46 (included in the carcass 12) and the length direction of the RFID tag 54 may be not less than 80 degrees and not greater than 90 degrees.

In the tire 2, an organic fiber cord may be adopted as each carcass cord 46. In a tire in which an organic fiber cord is used as each carcass cord 46, each sidewall portion of the tire may bend more easily than in a tire in which a steel cord is used as each carcass cord. Therefore, in the case where the RFID tag 54 is mounted to the tire in which an organic fiber cord is used as each carcass cord, depending on the orientation of the RFID tag 54, the RFID tag 54 may be likely to be significantly influenced by bending of the sidewall portion and could be easily damaged.

Under such circumstances, the RFID tag 54 may be placed such that the angle formed between the length direction thereof and the carcass cord 46 is close to 90 degrees, and the above-described influence of bending on the RFID tag 54 can be reduced.

In an implementation, in the tire 2, the angle θ formed between the length direction of the RFID tag 54 and the carcass cord 46 may be set to be not less than 80 degrees and not greater than 90 degrees.

In an implementation, the angle θ may be closer to 90 degrees.

Here, the angle θ means the angle formed between the length direction of the RFID tag 54 and a carcass cord 46A closest to the center of the semiconductor chip 58 of the RFID tag 54 when the tire 2 is viewed in the axial direction.

The center of the semiconductor chip 58 when the tire 2 is viewed in the axial direction means the center of the circumscribed rectangle of the semiconductor chip 58 (the point of intersection of the diagonals of the circumscribed rectangle) when viewed in the axial direction.

In FIG. 1, a length indicated by a double-headed arrow t is the shortest distance from the outer surface of the tire 2 to the RFID tag 54. The shortest distance t may be the thickness of the rubber covering the RFID tag 54.

In the tire 2, the shortest distance t may be not less than 3.5 mm. Accordingly, the RFID tag 54 may be covered with rubber having a sufficient thickness. In the tire 2, promotion of an increase in strain by the presence of the RFID tag 54 may be effectively suppressed. In the tire 2, occurrence of damage due to the presence of the RFID tag 54 may be effectively suppressed. In an implementation, the shortest distance t may be not less than 4.0 mm. The upper limit of the shortest distance t may depend on the position of the RFID tag 54, and the upper limit of the shortest distance t may be a suitable upper limit.

In the tire 2, the tag member 26 may be located axially outward of the outer apex 42 on the radially outer side of the end PF of the turned-up portion 50. In this case, the tag member 26 may be in contact with the outer apex 42. The boundary between the tag member 26 and the outer apex 42 may form a part of the outer surface of the outer apex 42. In an implementation, the boundary between the tag member 26 and the outer apex 42 may form a part of the outer surface of the apex 38.

In the tire 2, the RFID tag 54 may be located between the outer end PG2 of the outer apex 42 and the end PF of the turned-up portion 50 in the radial direction.

The RFID tag 54 of the tire 2 may be placed in the bead portion where the degree of bending is small. In the tire 2, the risk of damage to the RFID tag 54 may be low.

In the tire 2, the outer apex 42, which may be softer than the inner apex 40, may be located axially inward of the RFID tag 54, and promotion of an increase in strain by the presence of the RFID tag 54 may be effectively suppressed. In the tire 2, occurrence of damage due to the presence of the RFID tag 54 may be suppressed. Moreover, damage to the RFID tag 54 itself may also be suppressed. In the tire 2, the RFID tag 54 may be incorporated therein, and good durability may be maintained.

In an implementation, from the viewpoint of maintaining good durability while achieving formation of a good communication environment and reduction of the risk of damage to the RFID tag 54, the tag member 26 may be in contact with the outer apex 42 on the radially outer side of the end PF of the turned-up portion 50, and the RFID tag 54 may be located between the outer end PG2 of the outer apex 42 and the end PF of the turned-up portion 50 in the radial direction. In an implementation, from the same viewpoint, the RFID tag 54 may be located between the outer end PG2 of the outer apex 42 and the outer end PB of the chafer 8 in the radial direction.

In the tire 2, the entire tag member 26 may be located radially outward of the outer end PB of the chafer 8. The interference of the tag member 26 with the outer end PB of the chafer 8 may be effectively suppressed, so that waving (i.e., creasing) of the outer end PB of the chafer 8 may be effectively suppressed. Promotion of an increase in strain by the presence of the RFID tag 54 may be effectively suppressed. In the tire 2, occurrence of damage due to the presence of the RFID tag 54 may be suppressed. Moreover, damage to the RFID tag 54 itself may also be suppressed. In the tire 2, the RFID tag 54 may be incorporated therein, and good durability may be maintained.

In the tire 2, the entire tag member 26 may be located radially inward of the outer end PG2 of the outer apex 42. Accordingly, the influence of the tag member 26 on bending of the sidewall portion may be effectively suppressed. In the tire 2, good durability and ride comfort may be maintained. In an implementation, from this viewpoint, the outer end 26s of the tag member 26 may be located radially inward of the outer end PG2 of the outer apex 42.

In the tire 2, the outer end PU of the inner apex 40 may be located between the end PF of the turned-up portion 50 and the RFID tag 54 in the radial direction. Accordingly, the hard inner apex 40 may help effectively increase the stiffness of the bead portion. The strain acting on the RFID tag 54 may be effectively reduced. Promotion of an increase in strain by the presence of the RFID tag 54 may be effectively suppressed. In an implementation, from this viewpoint, the outer end PU of the inner apex 40 may be located between the end PF of the turned-up portion 50 and the RFID tag 54 in the radial direction. In this case, from the viewpoint of being able to more effectively suppress promotion of an increase in strain by the presence of the RFID tag 54, the outer end PU of the inner apex 40 may be located between the end PF of the turned-up portion 50 and the RFID tag 54 in the radial direction, and further the outer end PU of the inner apex 40 may be located between the end PF of the turned-up portion 50 and the outer end PB of the chafer 8 in the radial direction.

In an implementation, as described above, the tire 2 may be a heavy duty tire in which, in each bead portion, the end PF of the turned-up portion 50 may be located axially outward of the apex 38, or the structure of each bead portion in the heavy duty tire may have another suitable structure.

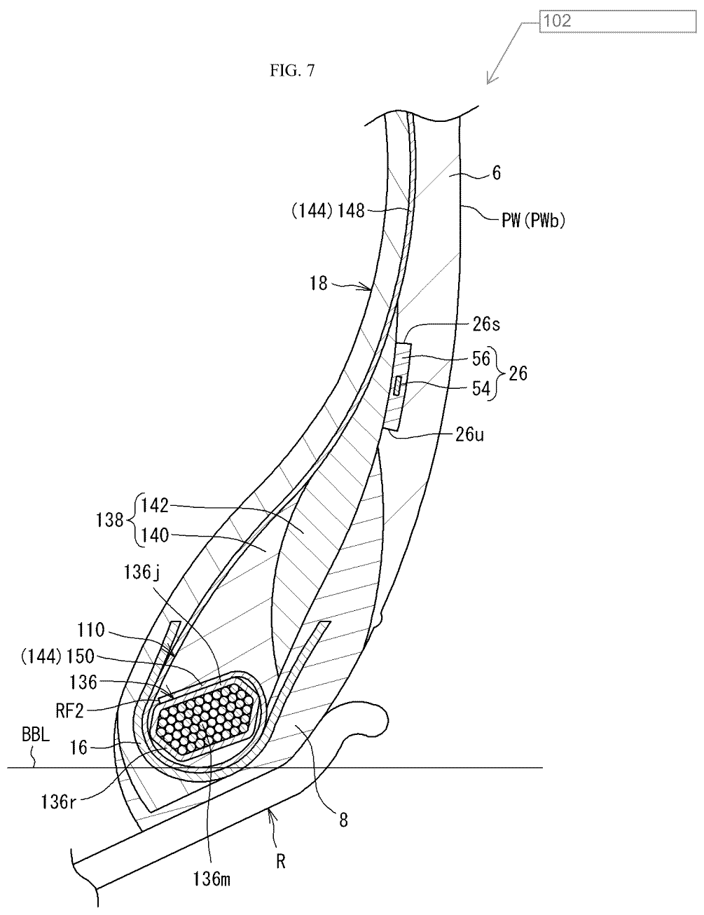

FIG. 7 is a cross-sectional view showing a part of a heavy duty tire 102 (hereinafter referred to as tire 102) according to another embodiment of the present disclosure.

The tire 102 may have the same configuration as the tire 2, except that the position of the end of the turned-up portion of the carcass ply in each bead portion may be different. In FIG. 7, components other than a carcass ply 144 and a bead 110 are designated by the same reference characters as in FIG. 2.

The bead portion of the tire 102 shown in FIG. 7 may have a structure in which: a turned-up portion 150 of the carcass ply 144 is wound around a core 136 substantially in a single turn while being turned up from the inner side toward the outer side in the axial direction on the radially inner side of the bead 110; and an end RF2 of the turned-up portion 150 along a radially upper surface 136j of the core 136 may be between the core 136 and an apex 138 (sometimes referred to as a bead-winding structure). In the tire 102, the apex 138 may have an inner apex 140 and an outer apex 142, and the end RF2 of the turned-up portion 150 may be between the radially upper surface 136j of the core 136 (wrapping layer 136r) and the inner apex 140.

In FIG. 7, reference character 136m denotes a core body, and reference character 148 denotes a ply body.

In the tire 102, the end RF2 of the turned-up portion 150 may be between the core 136 and the inner apex 140 which may be harder than the outer apex 142 and the chafer 8. Therefore, in the tire 102, strain in the vicinity of the end RF2 of the turned-up portion 150 may be particularly less likely to occur.

In the tire 102, an organic fiber cord, which is more flexible than a steel cord, may be adopted as each carcass cord. Therefore, in the tire 102, strong bending back of each turned-up portion (so-called spring back) in a green tire molding process or the like, which could be likely to occur in the case if a steel cord were to be adopted as each carcass cord in a tire having a bead-winding structure, may be less likely to occur.

In the tire 102 in which an organic fiber cord is adopted as each carcass cord, the above-described spring back may be less likely to occur, and molding defects such as formation of cavities in bead portions in a green tire molding process may be less likely to occur.

In the tire 102, the tag member 26 having the RFID tag 54 may be mounted at a predetermined position as in the tire 2. In an implementation, the tire 102 may also be a heavy duty tire having good performance in reading data from an RFID tag and having good durability.

In the tire 102, the core 136 may be further coated with a vulcanized rubber layer around the wrapping layer 136r.

According to the present disclosure, the heavy duty tire 2, which has good performance in reading data from an RFID tag and has good durability, may be obtained.

The above-described technology can be applied when mounting RFID tags to various tires.

### Additional Note

The present disclosure includes aspects described below.

[1] A heavy duty tire including:
a tread;
a pair of sidewalls each connected to an end of the tread and located radially inward of the tread;
a pair of beads each located radially inward of the sidewall;
a carcass located inward of the tread and the pair of sidewalls and extending on and between one bead and the other bead;
a belt stacked on the carcass on a radially inner side of the tread;
a pair of chafers each located radially inward of the sidewall and configured to come into contact with a rim; and
a tag member including an RFID tag, wherein
the bead includes a core and an apex located radially outward of the core,
the carcass includes a carcass ply including a plurality of carcass cords aligned with each other,
the carcass cords are formed from an organic fiber,
the carcass ply includes a ply body extending between the pair of beads and a pair of turned-up portions each connected to the ply body and turned up around the bead,
the rim is a standardized rim,
a state where the tire is fitted on the rim and an internal pressure of the tire is adjusted to a standardized internal pressure is a standardized state,
a state where a load that is 50% of the standardized load is applied to the tire in the standardized state and the tire is brought into contact with a flat surface is a standard ground-contact state,
in the standard ground-contact state, an end of the turned-up portion is located inward of an axially outer end of the rim in an axial direction,
in the standard ground-contact state, the RFID tag is located outward of the axially outer end of the rim in the axial direction and is located outward of a radially outer end of the rim in a radial direction, and
an angle formed between a length direction of the RFID tag and the carcass cord is not less than 80 degrees and not greater than 90 degrees.

[2] The heavy duty tire according to [1] above, wherein the carcass cords are formed from an aramid fiber.

[3] The heavy duty tire according to [1] or [2] above, wherein the RFID tag is located inward of a maximum width position of the tire in the radial direction in the standard ground-contact state.

[4] The heavy duty tire according to any one of [1] to [3] above, further comprising a band located between the tread and the belt in the radial direction and having two ends opposed to each other across an equator plane.

[5] The heavy duty tire according to any one of [1] to [4] above, wherein the end of the turned-up portion is interposed between the core and the apex.

[6] The heavy duty tire according to any one of [1] to [4] above, wherein
the end of the turned-up portion is located axially outward of the apex, and
a distance LB in the axial direction between the RFID tag and the axially outer end of the rim in the standard ground-contact state is longer than a distance LA in the axial direction between the end of the turned-up portion and the axially outer end of the rim in the standard ground-contact state.

What is claimed is:

1. A heavy duty tire, comprising:
a tread;
a pair of sidewalls each connected to an end of the tread and located radially inward of the tread;
a pair of beads each located radially inward of the sidewall;
a carcass located inward of the tread and the pair of sidewalls and extending on and between one bead and another bead;
a belt stacked on the carcass on a radially inner side of the tread;
a pair of chafers each located radially inward of the sidewall and configured to come into contact with a rim; and
a tag holder including an RFID tag, wherein
the beads each include a core and an apex located radially outward of the core,
the carcass includes a carcass ply including a plurality of carcass cords aligned with each other,
the carcass cords are formed from an organic fiber,
the carcass ply includes a ply body extending between the pair of beads and a pair of turned-up portions each connected to the ply body and turned up around the bead,
the rim is a standardized rim,
a state where the tire is fitted on the rim and an internal pressure of the tire is adjusted to a standardized internal pressure is a standardized state,
a state where a load that is 50% of a standardized load is applied to the tire in the standardized state and the tire is brought into contact with a flat surface is a standard ground-contact state,
in the standard ground-contact state, ends of the turned-up portions are located inward of an axially outer end of the rim in an axial direction,
in the standard ground-contact state, the RFID tag is located outward of the axially outer end of the rim in the axial direction and is located outward of a radially outer end of the rim in a radial direction, and
an angle formed between a length direction of the RFID tag and a length direction of the carcass cord is not less than 80 degrees and not greater than 90 degrees.

2. The heavy duty tire according to claim 1, wherein the carcass cords are formed from an aramid fiber.

3. The heavy duty tire according to claim 1, wherein the RFID tag is located inward of a maximum width position of the tire in the radial direction in the standard ground-contact state.

4. The heavy duty tire according to claim 1, further comprising a band located between the tread and the belt in the radial direction and having two ends opposed to each other across an equator plane.

5. The heavy duty tire according to claim 1, wherein the ends of the turned-up portions are between the core and the apex.

6. The heavy duty tire according to claim 1, wherein:
the ends of the turned-up portions are located axially outward of the apex, and
a distance LB in the axial direction between the RFID tag and the axially outer end of the rim in the standard ground-contact state is longer than a distance LA in the axial direction between the end of the turned-up portion and the axially outer end of the rim in the standard ground-contact state.

7. The heavy duty tire according to claim 1, wherein, in the standard ground-contact state, the RFID tag is located outward of the radially outer end of the rim in the radial direction and is located inward of a maximum width position of the heavy duty tire in the radial direction.

8. The heavy duty tire according to claim 1, wherein an angle formed between a length direction of the RFID tag and a length direction of the carcass cord is 90 degrees.

9. The heavy duty tire according to claim 1, wherein a distance in the axial direction between the ends of the turned-up portions and an axially outer end of the rim is less than a distance in the axial direction between the RFID tag and the axially outer end of the rim.

10. The heavy duty tire according to claim 9, wherein the distance in the axial direction between the RFID tag and the axially outer end of the rim is not less than 1.5 times and not greater than 8.0 times the distance in the axial direction between the ends of the turned-up portions and the axially outer end of the rim.

11. A heavy duty tire that is mountable on a standardized rim such that a state where a load that is 50% of a standardized load is applied to the heavy duty tire in a state where the heavy duty tire is fitted on the standardized rim and an internal pressure of the tire is adjusted to a standardized internal pressure, and the tire is brought into contact with a flat surface is a standard ground-contact state, the heavy duty tire comprising:
a tread;
a pair of sidewalls each connected to an end of the tread and located radially inward of the tread;
a pair of beads each located radially inward of the sidewall;
a carcass located inward of the tread and the pair of sidewalls and extending on and between one bead and another bead;
a belt stacked on the carcass on a radially inner side of the tread;
a pair of chafers each located radially inward of the sidewall and configured to come into contact with a rim; and
a tag holder including an RFID tag, wherein
the beads each include a core and an apex located radially outward of the core,
the carcass includes a carcass ply including a plurality of carcass cords aligned with each other,
the carcass cords are formed from an organic fiber,
the carcass ply includes a ply body extending between the pair of beads and a pair of turned-up portions each connected to the ply body and turned up around the beads,
in the standard ground-contact state, ends of the turned-up portions are located inward of an axially outer end of the rim in an axial direction,
in the standard ground-contact state, the RFID tag is located outward of the axially outer end of the rim in the axial direction and is located outward of a radially outer end of the rim in a radial direction, and
an angle formed between a length direction of the RFID tag and a length direction of the carcass cord is not less than 80 degrees and not greater than 90 degrees.

12. The heavy duty tire according to claim 11, wherein the carcass cords are formed from an aramid fiber.

13. The heavy duty tire according to claim 11, wherein the RFID tag is located inward of a maximum width position of the tire in the radial direction in the standard ground-contact state.

14. The heavy duty tire according to claim 11, further comprising a band located between the tread and the belt in the radial direction and having two ends opposed to each other across an equator plane.

15. The heavy duty tire according to claim 11, wherein the ends of the turned-up portions are between the core and the apex.

16. The heavy duty tire according to claim 11, wherein:
the ends of the turned-up portions are located axially outward of the apex, and
a distance LB in the axial direction between the RFID tag and the axially outer end of the rim in the standard ground-contact state is longer than a distance LA in the axial direction between the end of the turned-up portion and the axially outer end of the rim in the standard ground-contact state.

17. The heavy duty tire according to claim 11, wherein, in the standard ground-contact state, the RFID tag is located outward of the radially outer end of the rim in the radial direction and is located inward of a maximum width position of the heavy duty tire in the radial direction.

18. The heavy duty tire according to claim 11, wherein an angle formed between a length direction of the RFID tag and a length direction of the carcass cord is 90 degrees.

19. The heavy duty tire according to claim 11, wherein a distance in the axial direction between the ends of the turned-up portions and an axially outer end of the rim is less than a distance in the axial direction between the RFID tag and the axially outer end of the rim.

20. The heavy duty tire according to claim 19, wherein the distance in the axial direction between the RFID tag and the axially outer end of the rim is not less than 1.5 times and not greater than 8.0 times the distance in the axial direction between the ends of the turned-up portions and the axially outer end of the rim.
